(19) United States
(12) Patent Application Publication
(10) Pub. No.: US 2006/0271934 A1
(43) Pub. Date: Nov. 30, 2006

(54) Computer-readable recording medium recording a service control program, and service control device and method

(75) Inventor: Yutaka Ezaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/369,911

(22) Filed: Mar. 8, 2006

(30) Foreign Application Priority Data
May 31, 2005 (JP) 2005-160559

(51) Int. Cl. G06F 9/46

(52) U.S. Cl. 718/100

(57) ABSTRACT

A computer-readable recording medium recording a service control program whereby providable services can be determined by using highly secure information. A device detector collects, via a controller, service profiles of devices connected to a network, and also acquires identification information of the controller. A usage condition acquisition unit acquires, from a management database, usage conditions for using nearby devices. An available service decision unit determines available services which can be provided by one or more devices including those on the network and which meet the usage conditions. A device controller remotely controls the device which is used for providing an available service among those determined by the available service decision unit, to provide the available service.

### CROSS-REFERENCE TO RELATED APPLICATIONS

This application is based upon and claims the benefits of priority from the prior Japanese Patent Application No. 2005-160559, filed on May 31, 2005, the entire contents of which are incorporated herein by reference.

### BACKGROUND OF THE INVENTION

1. Field of the Invention

The present invention relates to computer-readable recording media recording a service control program and service control devices and methods for controlling services to be provided for users in ubiquitous environments. More particularly, the present invention relates to a computer-readable recoding medium recording a service control program and service control device and method wherein services to be provided are controlled by Task Computing.

2. Description of the Related Art

At present, research and development are extensively conducted with a view to constructing ubiquitous environments wherein all possible devices are connected by networks. In the ubiquitous environment, users need not carry boxes in which all necessary functions are incorporated, such as notebook personal computers. Namely, wherever users may go, they can receive services available to them by using devices prepared at various places. An important point in building ubiquitous environments is how easily terminals can be discovered and services can be composed.

The concept called “Task Computing” has been proposed as a solution. Task Computing offers a mechanism wherein individual devices are assigned profiles of services to be provided thereby, the service profiles are collected by a controller to compose services, and the composed services are instructed how to behave, to thereby provide the user with matching services (cf. Masuoka and Yuhara, “Task Computing—Filling the Gap between Tasks and Services” (pp. 376-383), Magazine Fujitsu, July 2004 “Special Issue: Ubiquitous” (VOL. 55, NO. 4), published by Fujitsu Ltd.; URL on the Internet: http://magazine.fujitsu.com/vol55-4/paper18.pdf, search performed on May 26, 2005).

FIG. 17 shows a conventional system configuration for Task Computing. In Task Computing, devices, such as a camera 910 and a monitor 920, and a controller 930 are connected to the same LAN (Local Area Network) 950. The camera 910 and the monitor 920 each have a service profile which is information about the contents etc. of providable services.

The controller 930 comprises an operation unit 931, a controller application 932, a discovery engine 933, a composition engine 934, a control engine 935, and a communication controller 936. The operation unit 931 is a user interface for accepting an input operation keyed in by a user 940. The controller application 932 provides the user with various adaptive functions such as the screen display function. The discovery engine 933 collects service profiles from the devices connected to the LAN 950 and detects services that the individual devices can provide. The composition engine 934 composes services of a plurality of devices and determines composite services that can be provided by multiple devices. In response to a service start instruction from the user 940, the control engine 935 remotely controls the device which is used for providing the corresponding service, to cause the device to start the service. The communication controller 936 controls communications via the LAN 950.

A processing procedure will be now explained with reference to an exemplary case where video captured by the camera 910 is displayed on the monitor 920.

First, the controller 930 acquires the service profile from the camera 910 (Step S91) and also acquires the service profile from the monitor 920 (Step S92). The discovery engine 933 analyzes the contents of the acquired service profiles and recognizes the function of the camera 910 (e.g., the function of outputting captured video as MPEG (Moving Picture Experts Group) data) as well as the function of the monitor 920 (e.g., the function of reproducing and displaying input MPEG data).

The composition engine 934 then recognizes that video captured by the camera 910 can be displayed on the monitor 920, whereupon the controller application 932 displays on the screen a message that a composite service of the functions can be provided. The user 940 enters through the operation unit 931 an instruction to execute the displayed service (Step S93).

In response to the instruction, the control engine 935 instructs the camera 910 to capture and transmit video data (Step S94). Also, the control engine 935 instructs the monitor 920 to acquire, reproduce, and display the video data.

Consequently, video data is transmitted as a data stream from the camera 910 to the monitor 920 (Step S96), so that the video captured by the camera 910 is displayed on the monitor 920.

The conventional Task Computing is, however, based on the assumption that the function of the controller is performed by a PDA (Personal Digital Assistant) or a mobile telephone, and thus there are restrictions on the quality of services to be provided.

Let us consider the case where restrictions are imposed on devices which each user is allowed to use, for example. In this case, whether services may be composed or not must be determined in accordance with each user's authority. Also, information about each user's authority to use devices needs to be managed by a server, not by the controller, in order to prevent the information from being rewritten by the user. Namely, to prevent unauthorized use of devices, information about the user's authority should not be stored in the controller. It is therefore difficult to place restrictions on the use of devices by individual users in the Task Computing framework.

Also, portable controllers such as PDAs generally have small-sized display screens. Thus, if providable services are simply listed on the screen of the controller, it takes time and labor for the user to locate a target service. Accordingly, the order of services displayed should desirably be optimized in accordance with the user's personal information. It is, however, not advisable to store the user's personal information in the controller which is carried about with the user, because it may lead to leak of the personal information.

### SUMMARY OF THE INVENTION

The present invention was created in view of the above circumstances, and an object thereof is to provide a computer-readable recording medium recording a service control program and service control device and method whereby providable services can be determined by using highly secure information.

To achieve the object, there is provided a computer-readable recording medium recording a service control program for controlling services that can be provided through collaboration of devices on a network to which a controller is connected. The service control program recorded on the recording medium causes a computer to function as a device detector, a usage condition acquisition unit, an available service decision unit, and a device controller. The device detector communicates with the controller to collect service profiles of nearby devices connected to a network in the vicinity of the controller. The usage condition acquisition unit looks up a management database in which usage conditions for using individual devices are registered beforehand, to acquire usage conditions of the nearby devices corresponding to the service profiles acquired by the device detector. The available service decision unit determines, based on the service profiles acquired by the device detector and the usage conditions acquired by the usage condition acquisition unit, available services that can be provided by one or more devices including the nearby devices. The device controller remotely controls a device which is used for providing an available service among those determined by the available service decision unit, to provide the available service.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 illustrates an outline of an embodiment of the present invention.

FIG. 2 shows an exemplary system configuration of a first embodiment.

FIG. 3 shows an exemplary hardware configuration of a network server used in the embodiment.

FIG. 4 is a block diagram illustrating functions of the network server and a controller.

FIG. 5 shows an exemplary data structure of a device management database.

FIG. 6 shows an exemplary data structure of a controller management database.

FIG. 7 shows an exemplary data structure of a user management database.

FIG. 8 illustrates a procedure for Task Computing.

FIG. 9 is a first diagram showing a service profile.

FIG. 10 is a second diagram showing the service profile.

FIG. 11 is a third diagram showing the service profile.

FIG. 12 is a block diagram showing the internal arrangement of a probe.

FIG. 13 is a sequence diagram illustrating a service profile collection process.

FIG. 14 shows the arrangement of a probe according to a second embodiment.

FIG. 15 is a sequence diagram illustrating a service profile collection process according to the second embodiment.

FIG. 16 shows an exemplary system configuration according to a third embodiment.

FIG. 17 shows a conventional system configuration for Task Computing.

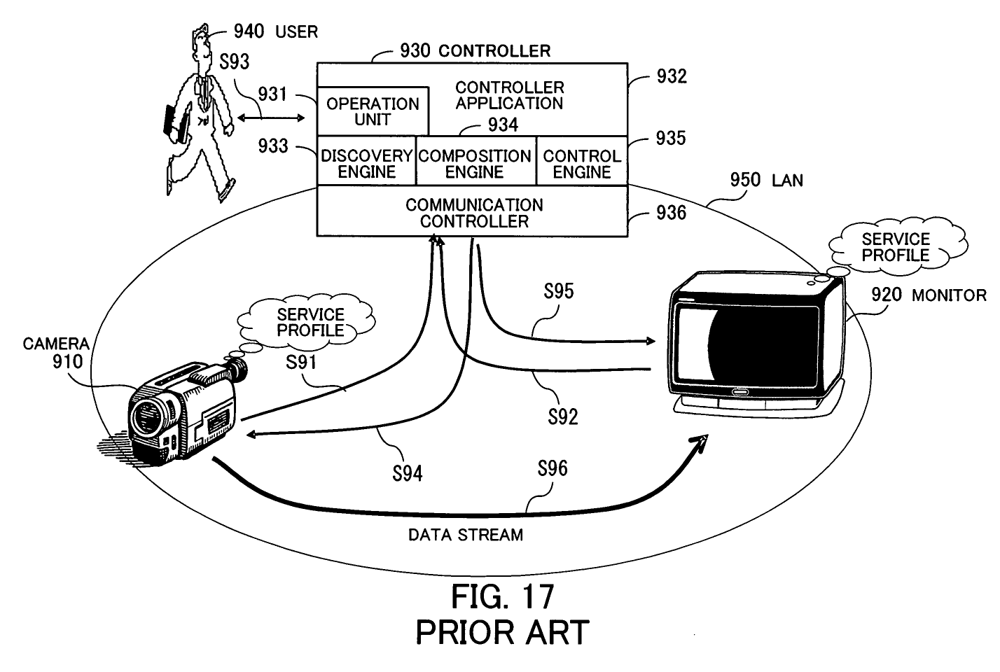

### DESCRIPTION OF THE PREFERRED EMBODIMENTS

Preferred embodiments of the present invention will be described below with reference to the accompanying drawings, wherein like reference numerals refer to like elements throughout.

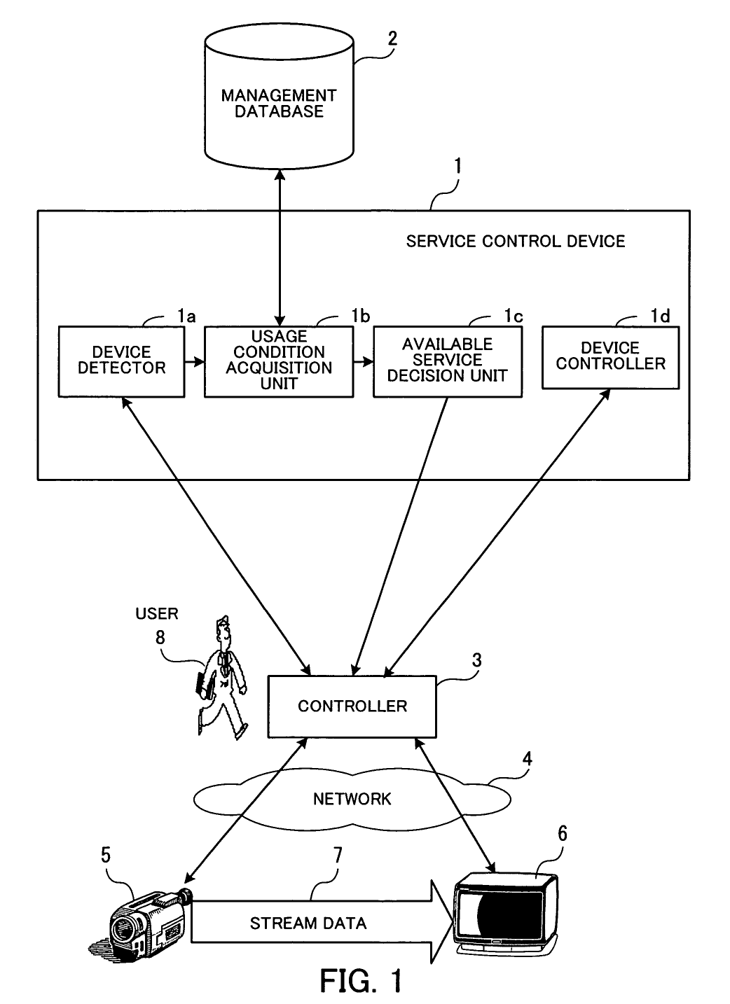

FIG. 1 illustrates an outline of an embodiment of the invention. A service control device 1 is adapted to control services that can be provided through collaboration of devices (e.g., a camera 5 and a monitor 6) on a network 4 to which a controller 3 is connected. To this end, the service control device comprises a device detector 1a, a usage condition acquisition unit 1b, an available service decision unit 1c, and a device controller 1d.

The device detector 1a communicates with the controller 3 to collect service profiles of nearby devices connected to the network 4 in the vicinity of the controller 3. Devices in the vicinity of the controller 3 signify, for example, the devices connected to a segment to which the controller 3 is also connected or the devices belonging to the same subnet as the controller 3. The device detector 1a can also acquire identification information on the user 8 from the controller 3 when collecting service profiles.

The above process of the device detector 1a is executed, for example, when the user 8 connects the controller 3 to the network 4. The identification information of the user 8 may be information whereby the user 8 can be uniquely identified. For example, where the identification information of the controller 3 and that of the user 8 are previously associated with each other, the identification information of the controller 3 may be used as the identification information of the user 8.

The usage condition acquisition unit 1b looks up a management database 2 in which usage conditions for using the individual devices are registered beforehand. In the management database 2 are registered, for example, user information about services which the user 8 is authorized to use, and conditions for using the individual devices (e.g., authority required for the user, available time). Based on the controller identification information acquired by the device detector 1a, the usage condition acquisition unit 1b acquires the user information about the user 8 using the controller 3.

The available service decision unit 1c determines, based on the service profiles acquired by the device detector 1a and the user information acquired by the usage condition acquisition unit 1b, available services which can be provided by one or more devices including the devices on the network 4 and which the user 8 is authorized to use.

The device controller 1d remotely controls a device(s) used for providing an available service among those determined by the available service decision unit 1c, to provide the available service. The remote control of the device(s) is carried out, for example, via the controller 3.

The following describes the case where the user 8 uses a service whereby video captured by the camera 5 is displayed on the monitor 6. In this case, first, the controller 3 used by the user 8 is connected to the network 4. The device detector 1a collects, via the controller 3, the service profiles of the camera 5 and the monitor 6 connected to the network 4. At this time, the device detector 1a acquires the identification information of the controller 3.

Subsequently, the usage condition acquisition unit 1b looks up the management database 2 to acquire, based on the controller identification information acquired by the device detector 1a, the user information about the user 8 using the controller 3. It is assumed here that the user 8 is authorized to use the camera 5 and the monitor 6.

Then, based on the service profiles acquired by the device detector 1a and the user information acquired by the usage condition acquisition unit 1b, the available service decision unit 1c judges that video display service by means of the camera 5 and the monitor 6 is available. The device controller 1d remotely controls the camera 5 and the monitor 6 so that the video captured by the camera 5 may be transmitted as stream data 7 to the monitor 6 and displayed on the monitor 6.

Thus, only when conditions set with respect to each user, such as restrictions on the use of devices, are met, the user can use services, and it is therefore possible to control the provision of services according to each user's authority in the Task Computing framework. Further, since information on the authority to use services need not be stored in the controller 3 owned by the user 8, unauthorized use of services can be prevented.

Embodiments of the present invention will be now described in detail.

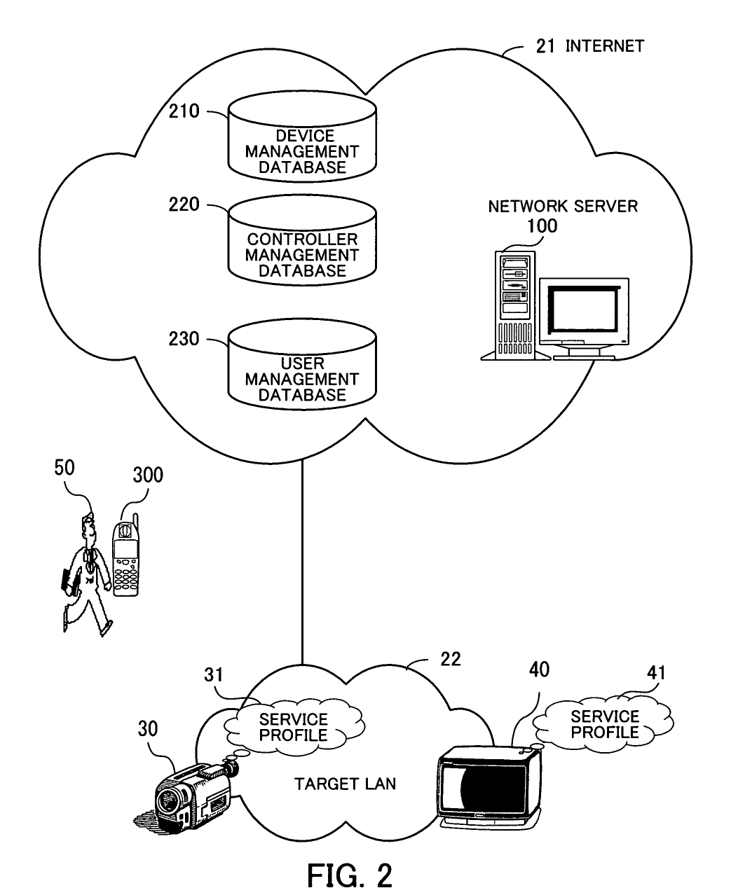

FIG. 2 shows an exemplary system configuration according to a first embodiment. The figure illustrates, by way of example, a system wherein Task Computing is applied so as to make use of shared facilities of a corporation, such as a shared conference room.

In the first embodiment, a target LAN 22 is connected to the Internet 21. The target LAN 22 is a LAN which is so configured as to provide services by Task Computing.

To the Internet 21 are connected a network server 100, a device management database 210, a controller management database 220, and a user management database 230. The network server 100 performs a Task Computing process such as the decision of services that can be provided for the user using a controller 300. When determining providable services, the network server 100 looks up the device management database 210, the controller management database 220 and the user management database 230 to decide the contents of providable services.

The device management database 210 is a database for managing information about devices used for providing services. The controller management database 220 is a database for managing information about controllers used by individual users. The user management database 230 is a database for managing information about users for whom services are provided by Task Computing.

To the target LAN 22 are connected a plurality of devices for providing users with services. In the example of FIG. 2, a camera 30 (e.g., a camera device integrated with video recording function) and a monitor 40 (e.g., a television set connectible to networks) are connected to the target LAN 22. The camera 30 has a service profile 31 in which is set information such as the contents of services that the camera 30 can provide. Similarly, the monitor 40 has a service profile 41 in which is set information such as the contents of services that the monitor can provide. In each of the service profiles 31 and 41, the name of the device, input/output conditions, operation summary, prerequisites for operation, etc. are described in XML (extensible Markup Language) format, for example.

The controller 300 is possessed by a user 50. The controller 300 is connected to the target LAN 22, whereupon the controller 300 collects service profiles from the other devices on the target LAN and transfers the collected profiles to the network server 100. Subsequently, the controller 300 receives, from the network server 100, a list of services available to the user 50, among the services provided by the devices on the target LAN 22. The controller 300 then displays the received list of services on its screen and, in response to a selection of an optional service by the user 50, transmits the contents of the selected service to the network server 100.

The system configured as described above allows the user 50 to use services provided by Task Computing.

The Task Computing according to this embodiment is characterized in that the service control function is incorporated in the network server 100 and not in the controller 300 used by the user 50. To enable the network server 100 to perform the service control function, schemes mentioned below are adopted.

(1) The controller 300 is provided with a “probe function” for detecting the status of the target LAN 22.

(2) The network server 100 is provided with a “service control function” for composing services, which function is logically connected with the probe function.

(3) Various databases are provided on the Internet 21 such that the network server 100 can access the databases, and also supplementary information about the devices and the user 50 is stored in the databases beforehand.

(4) Information about the target LAN 22, obtained by the probe function of the controller 300, is sent to the network server 100. The network server 100 then performs a service composition calculation, taking account of the supplementary information obtained by accessing the databases.

(5) The network server 100 displays, on the screen of the controller 300, suggested combinations of services based on the result of the composition calculation, and then decides a service to be provided in accordance with an instruction from the user 50.

(6) The network server 100 transmits an operation instruction to devices associated with the specified service.

(7) The devices are remotely controlled by the network server 100 to cooperatively provide the service for the user 50.

The following describes the hardware configuration of the individual devices, such as the network server 100, for accomplishing the above functions.

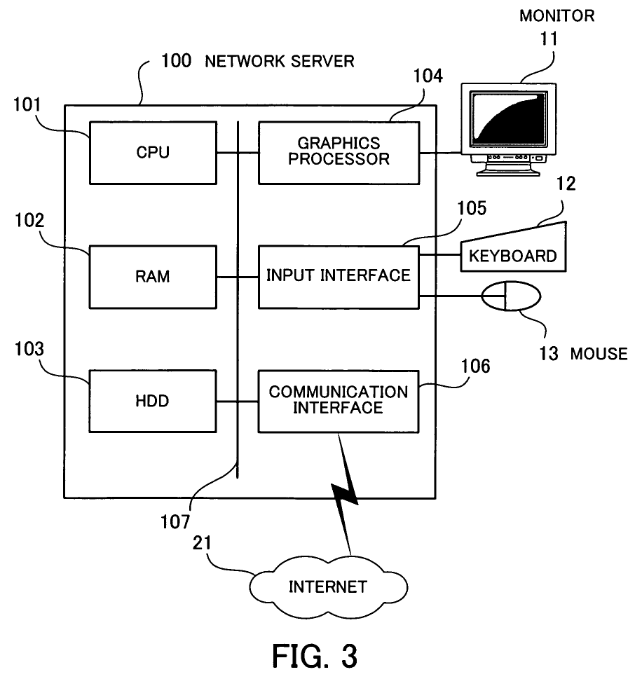

FIG. 3 shows an exemplary hardware configuration of the network server used in the embodiment. The network server 100 is in its entirety under the control of a CPU (Central Processing Unit) 101. To the CPU 101 are connected, via a bus 107, a RAM (Random Access Memory) 102, an HDD (Hard Disk Drive) 103, a graphics processor 104, an input interface 105, and a communication interface 106.

The RAM 102 temporarily stores OS (Operating System) programs and at least part of application programs executed by the CPU 101. Also, the RAM 102 stores various other data necessary for the processing by the CPU 101. The HDD 103 stores the OS and application programs.

The graphics processor 104 is connected with a monitor 11. In accordance with instructions from the CPU 101, the graphics processor 104 displays images on the screen of the monitor 11. The input interface 105 is connected with a keyboard 12 and a mouse 13, and sends signals from the keyboard 12 and the mouse 13 to the CPU 101 via the bus 107.

The communication interface 106 is connected to the Internet 21 and permits data to be exchanged with other computers via the Internet 21.

The processing function of the embodiment can be implemented by the hardware configuration described above. Although FIG. 3 shows the hardware configuration of the network server 100, the controller 300 also may have a similar hardware configuration. In the case of the controller 300, however, the monitor and the keyboard are built into the casing. Also, in the controller 300, other pointing device than the mouse, such as a control pad, is used. Further, the controller 300 may use a nonvolatile semiconductor memory such as flash memory, in place of the HDD.

The processing functions of the network server 100 and the controller 300 for accomplishing the Task Computing will be now described in detail.

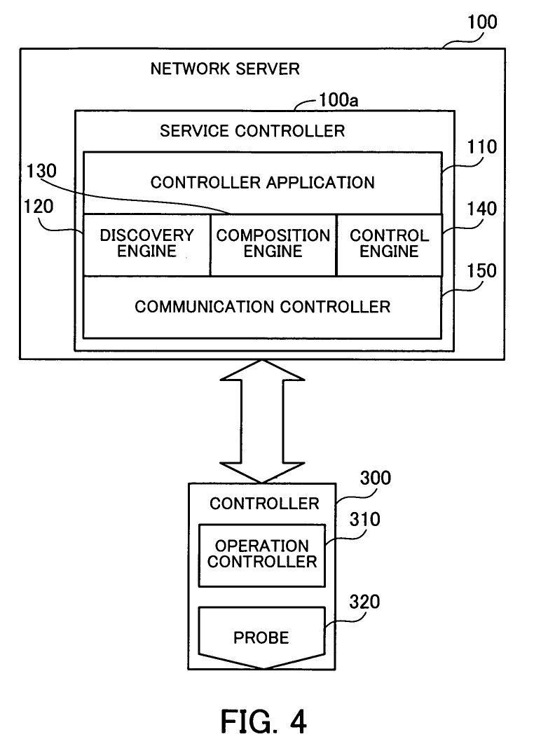

FIG. 4 is a block diagram illustrating the functions of the network server and the controller. The network server 100 has a service controller 100a for executing the Task Computing process. The service controller 100a comprises a controller application 110, a discovery engine 120, a composition engine 130, a control engine 140, and a communication controller 150.

The controller application 110 executes various processes for the controller 300. For example, the controller application 110 rearranges, in predetermined order, a list of services available to the user 50.

The discovery engine 120 detects devices on the target LAN 22 to which the controller 300 is connected, and also detects services that the detected devices can provide. Specifically, the discovery engine 120 detects, through the controller 300, devices connected to the target LAN 22. Further, the discovery engine 120 collects the service profiles of the devices detected through the controller 300, and analyzes the collected service profiles to identify the services that the individual devices can provide.

The composition engine 130 determines composite services which can be provided by combining the services detected by the discovery engine 120. At this time, the composition engine 130 acquires information (including restrictive conditions for using services) about the user 50, the controller 300 and the detected devices (camera 30, monitor 40) from the device management database 210, the controller management database 220 and the user management database 230, and determines services meeting restrictive conditions, among the composite services which can be provided by combining the services.

Also, the composition engine 130 generates a list of services meeting the restrictive conditions. The generated list is rearranged in predetermined order by the controller application 110. Then, the composition engine 130 transmits the thus-rearranged service list to the controller 300.

On receiving a service provision request from the controller 300, the control engine 140 transmits operation instructions to devices which are used to provide the corresponding service. The operation instructions are sent to the respective devices via the controller 300. For example, in the case where the received service provision request demands that video captured by the camera 30 be displayed on the monitor 40, the control engine 140 transmits, to the camera 30, a video capture instruction and a transfer instruction to transfer the captured video to the monitor 40 as a data stream. Also, the control engine 140 transmits, to the monitor 40, an acquisition instruction to acquire the data stream transmitted from the camera 30, and a video display instruction to reproduce the acquired data stream.

The communication controller 150 communicates data via networks such as the Internet 21. Communications between the network server 100 and the individual databases and between the network server 100 and the controller 300 are carried out by the communication controller 150.

The controller 300 has an operation controller 310 and a probe 320. The operation controller 310 is a user interface making use of display and input devices. Specifically, the operation controller 310 accepts an input operation keyed in by the user and instructs an operation matching the contents of the input operation. Also, the operation controller 310 displays, on the display device, the list of available services transmitted from the network server 100.

The probe 320 transmits/receives LAN packets and also collaborates with the service controller 100a of the network server 100. Specifically, the probe 320 detects devices connected to the target LAN 22 and collects service profiles from the detected devices. The probe 320 then transmits the collected service profiles to the network server 100.

Data stored in the individual databases shown in FIG. 2 will be now described in detail.

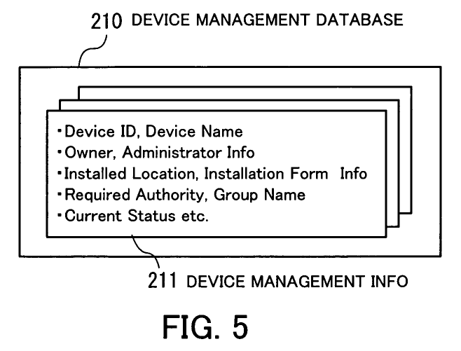

FIG. 5 shows an exemplary data structure of the device management database. The device management database 210 holds device management information 211 associated with each device. The device management information 211 includes “Device ID”, “Device Name”, “Owner”, “Administrator Information”, “Installed Location”, “Installation Form Information”, “Required Authority”, “Group Name”, “Current Status”, etc.

“Device ID” is identification information uniquely identifying the corresponding device, and “Device Name” is the name of the device. “Owner” indicates the name of the user who owns the device, and “Administrator Information” is information such as the name of the user who administers the device. “Installed Location” is information about the location where the device is installed, and “Installation Form Information” is information about the form of installation of the device (e.g., information indicating whether the device is fixed on the floor or is movable).

“Required Authority” indicates the authority that the user using the device should have. If the use of the device is restricted only to the department managers and higher-ranking officials in a corporation, for example, the condition that “the user should be in department manager or higher office” is set as “Required Authority”.

“Group Name” is the name of the group to which the device belongs, and in the case of permitting the user to use devices belonging to a certain group, the groups which the individual devices belong to are identified by “Group Name”.

“Current Status” is information about the status of the device. For example, information indicating whether the device is currently used or not is set as “Current Status”.

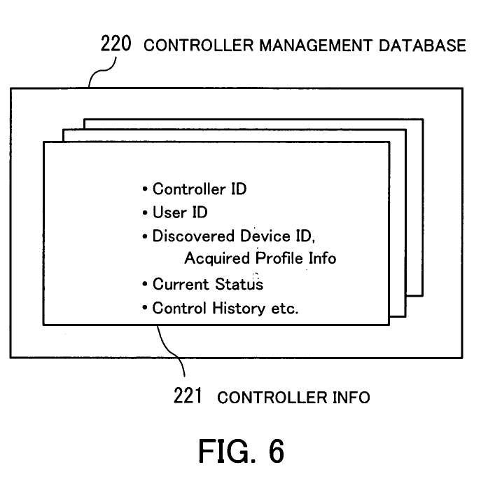

FIG. 6 shows an exemplary data structure of the controller management database. The controller management database 220 holds controller information 221 associated with each controller. The controller information 221 includes “Controller ID”, “User ID”, “Discovered Device ID”, “Acquired Profile Information”, “Current Status”, “Control History”, etc.

“Controller ID” is identification information uniquely identifying the corresponding controller, and “User ID” is identification information of the user using the controller. “Discovered Device ID” is identification information of a device discovered on the target LAN 22 to which the controller is connected, and “Acquired Profile Information” is profile information acquired from the discovered device. “Current Status” is information indicating the current usage status of the controller (e.g., information indicating whether the controller is connected to the target LAN 22 or not). “Control History” is historical information indicating the contents of Task Computing processes executed in the past in accordance with instructions from the controller.

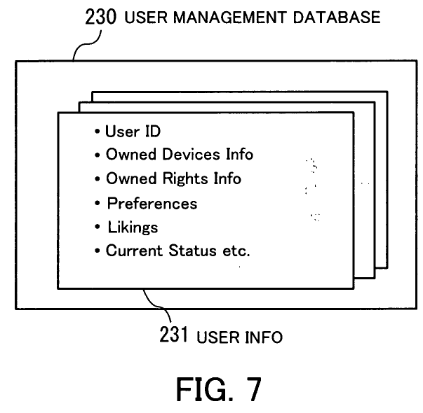

FIG. 7 shows an exemplary data structure of the user management database. The user management database 230 holds user information 231 associated with each user. The user information 231 includes “User ID”, “Owned Devices Information”, “Owned Rights Information”, “Preferences”, “Likings”, “Current Status”, etc.

“User ID” is identification information uniquely identifying the user who receives the Task Computing service. “Owned Devices Information” is a list of devices owned by the user, and “Owned Rights Information” is information about the rights owned by the user (e.g., information about music data which the user has the right to access, and information about devices which the user is authorized to use). “Likings” is information about the user's tastes and likings, and “Current Status” is information about the state of the user (e.g., information indicating whether the user is currently using service or not). Based on the information “Likings”, “Preferences” for service selection etc. are determined.

The system configured as described above performs the Task Computing process, following the procedure explained below.

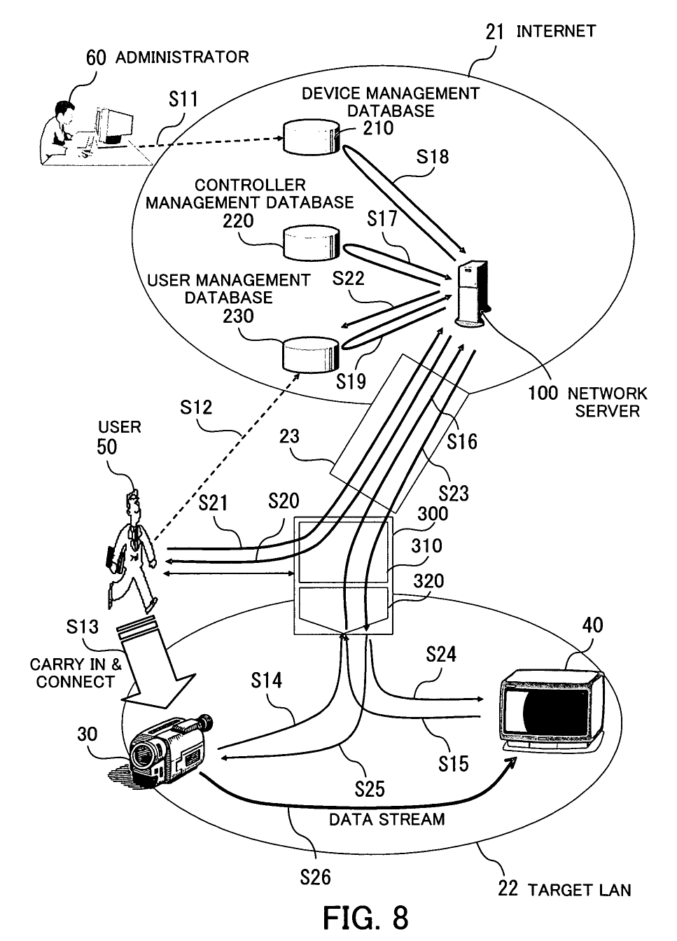

FIG. 8 illustrates the procedure for the Task Computing process. The flow of system operation will be explained with reference to an exemplary case where the camera 30 carried in by the user is connected to the monitor 40 installed in a conference room.

Setup Phase:

The monitor 40 has a service profile previously written therein. Also, device IDs, device names, administrator's name, authorized users, etc. are previously registered in the device management database 210 by an administrator 60 (Step S11).

The camera 30 also has a service profile previously written therein. Also, the user 50 registers, in the user management database 230, the user information that the camera 30 is owned by the user 50 (Step S12).

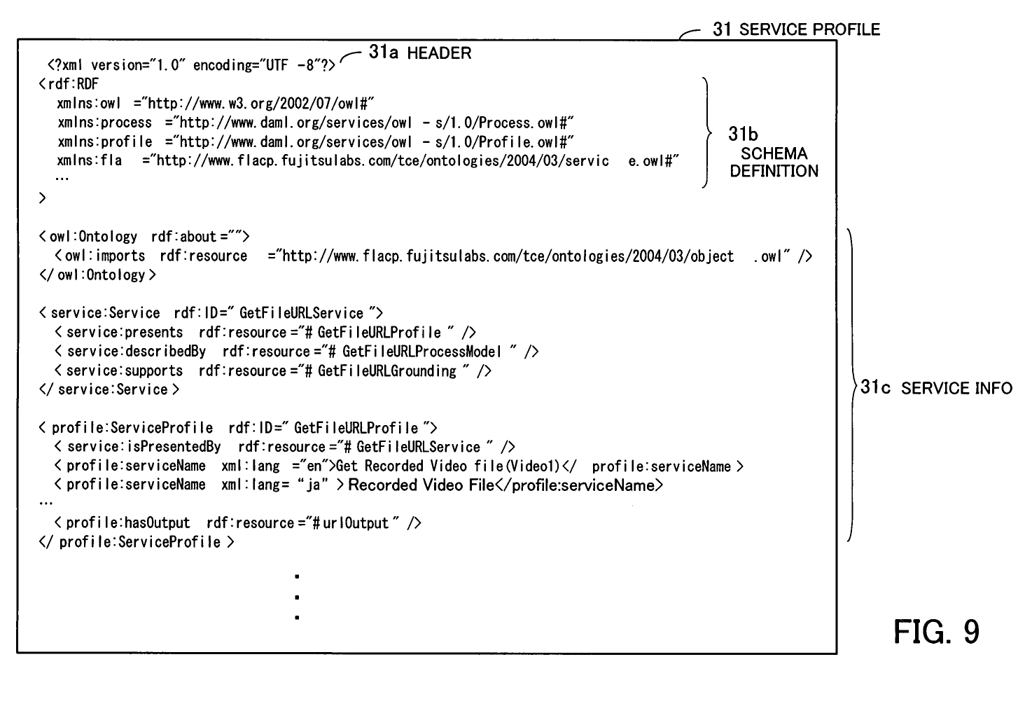

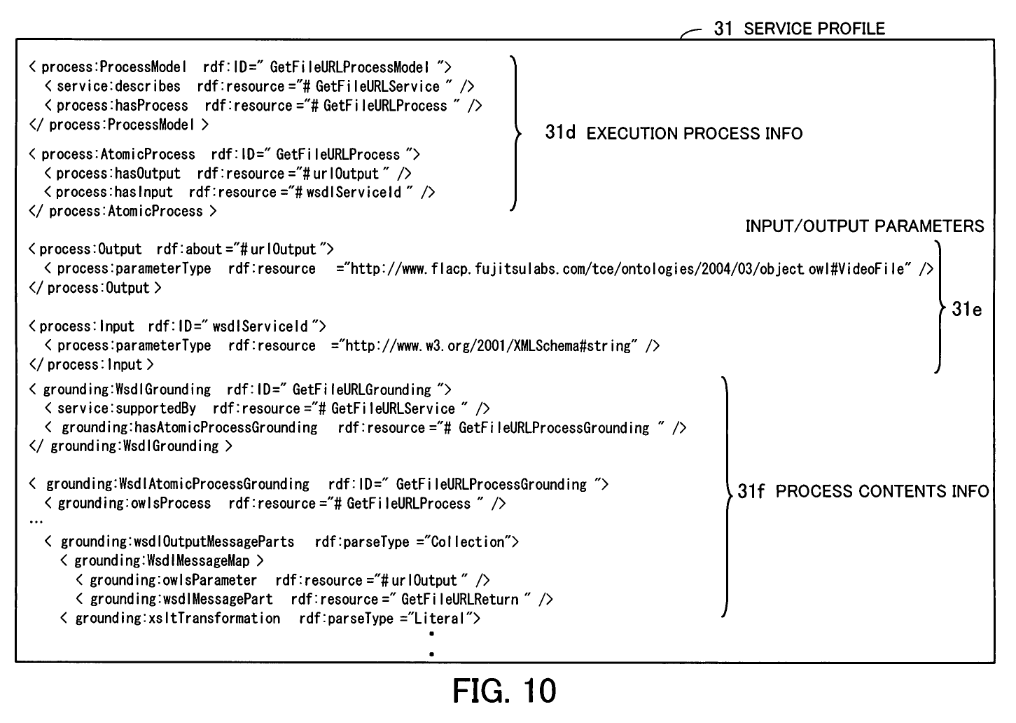

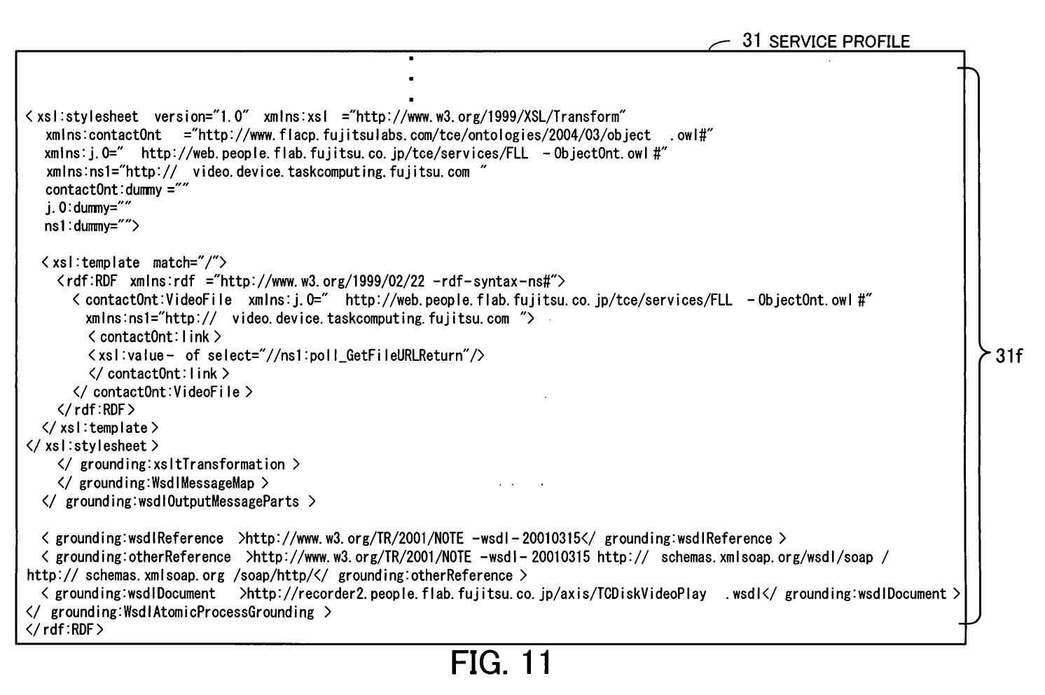

FIGS. 9, 10 and 11 are first, second and third diagrams illustrating an exemplary service profile 31 of the camera 30.

In the service profile 31, a header 31a is followed by a schema definition 31b, service information 31c, execution process information 31d, input/output parameters 31e, process contents information 31f, etc., all described in XML format.

Referring again to FIG. 8, the process will be explained.

Discovery Phase:

The user 50 connects the camera 30, which has the service profile 31 registered therein, to the target LAN 22 (Step S13). Then, the user 50 connects the controller 300 to the target LAN 22, whereupon the probe 320 discovers the camera 30 on the target LAN 22 and acquires the service profile from the camera 30 (Step S14). Similarly, the probe 320 discovers the monitor 40 on the target LAN 22 and acquires the service profile 41 from the monitor 40 (Step S15).

Subsequently, the probe 320 transmits the acquired service profiles 31 and 41 to the network server 100 (Step S16). In the illustrated example, communication between the controller 300 and the network server 100 is performed via the Internet 21. In this case, communication security can be ensured by connecting the controller 300 and the network server 100 via a VPN (Virtual Private Network) 23. Such a VPN may be configured by using tunneling techniques such as PPTP (Point-to-Point Tunneling Protocol), L2TP (Layer 2 Tunneling Protocol), and IPsec.

When transmitting the service profiles 31 and 41, the probe 320 also transmits the controller ID to the network server 100. The transmitted service profiles are received by the discovery engine 120 of the network server 100. The discovery engine 120 transfers the acquired service profiles to the composition engine 130.

Service Composition Phase:

Based on the received service profiles, the composition engine 130 of the network server 100 performs a service composition calculation while looking up the related databases, to identify available services. Specifically, the composition engine 130 acquires the controller information corresponding to the received controller ID from the controller management database 220 (Step S17).

Also, the composition engine 130 acquires the device IDs from the received service profiles and retrieves the device management information corresponding to the device IDs from the device management database 210 (Step S18). The composition engine 130 checks the acquired device management information to determine whether or not the individual devices can be used.

Further, the composition engine 130 extracts the user ID from the acquired controller information and retrieves the user information corresponding to the user ID from the user management database 230 (Step S19). By looking up “Owned Rights Information” in the acquired user information, the composition engine 130 can add other available services which the user has the right to use.

Also, when composing services, the composition engine 130 can determine the order of services to be displayed by taking into account the information “Likings” included in the user information. Further, where historical information on the user's past selections is included in the user information, the composition engine 130 may determine the order of services to be displayed in accordance with the history of selections.

The service composition calculation result (list of available services arranged in accordance with predetermined criteria), obtained by the composition engine 130, is transmitted via the VPN 23 to the controller 300 and is displayed on its screen by the operation controller 310 (Step S20). While viewing the list of services displayed on the screen, the user 50 selects a service he/she wishes to use, whereupon a request for provision of the selected service is transmitted from the controller 300 to the network server 100 (Step S21). This procedure may be accomplished, for example, by transmitting an HTML file adapted for ordinary browsers and allowing the user to make a selection on the browser installed on the controller 300.

Control Phase:

On receiving the service provision request from the user 50, the control engine 140 of the network server 100 creates control messages based on the information in the acquired service profiles. Subsequently, the control engine 140 transmits the created control messages to the related devices via the controller 300. At this time, the control engine 140 stores information about the user's selected service in the user management database 230 so that the result of selection can be learned (Step S22).

In accordance with instructions described in the control messages, the individual devices operate in collaboration with each other. For example, where the selected service demands that video captured by the camera 30 be displayed on the monitor 40, a data stream of video captured by the camera 30 is transferred to and displayed on the monitor 40 (Step S26).

The process of collecting service profiles via the probe 320 will be now described in detail. The probe 320 functions in a manner such that seemingly the controller 300, instead of the network server, is controlling the devices on the target LAN 22.

To implement the probe function, a method may be employed wherein the least possible functionality is incorporated in the controller 300 and all other necessary processes are executed by the network server. According to this method, the controller is provided only with the function of extracting specified packets by filtering and transferring the extracted packets to the server, and the function of transmitting packets received from the server onto the target LAN 22. For the filtering function, data describing header/data conditions for filtering is set by the server, whereby only specified packets can be extracted.

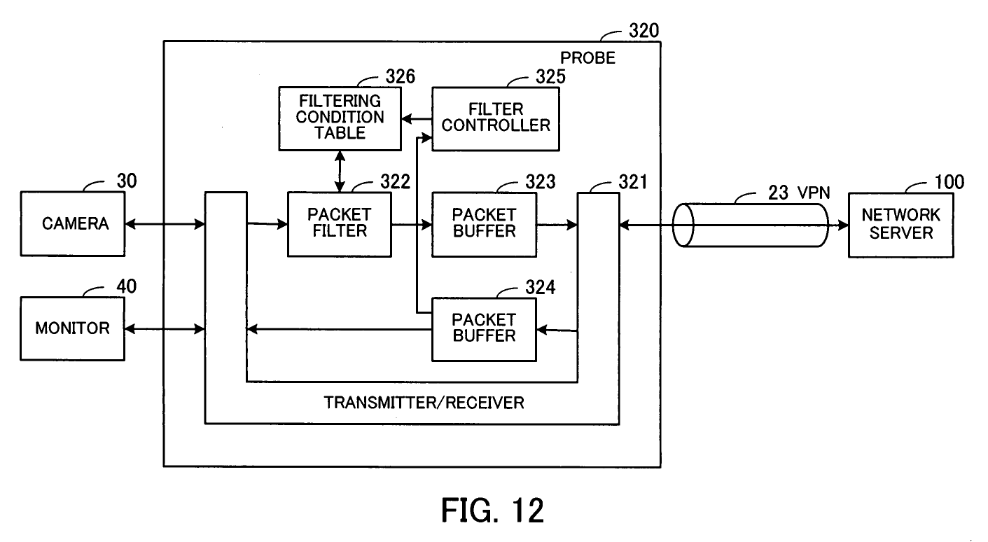

FIG. 12 is a block diagram showing the internal arrangement of the probe. The probe 320 comprises a transmitter/receiver 321, a packet filter 322, packet buffers 323 and 324, a filter controller 325, and a filtering condition table 326.

The transmitter/receiver 321 communicates data with the network server 100, the camera 30 and the monitor 40. Communication with the network server 100 is performed via the VPN 23.

Also, the transmitter/receiver 321 supplies packets received from the network server 100 to the packet buffer 324, and supplies packets received from the camera 30 or the monitor 40 to the packet filter 322. Further, the transmitter/receiver 321 acquires the packets input to the packet buffer 323 and transmits the acquired packets to the network server 100. Also, the transmitter/receiver acquires the packets input to the packet buffer 324 and transmits the acquired packets to the camera 30 or the monitor 40.

The packet filter 322 receives, via the transmitter/receiver 321, the packets transmitted from the camera 30 or the monitor 40. At this time, the packet filter 322 filters the packets in accordance with the filtering conditions set in the filtering condition table 326. Then, the packet filter 322 supplies the packet buffer 323 with only those packets to be transferred.

The packet buffer 323 stores the packets input from the packet filter 322. Then, the packet buffer 323 transfers the packets destined for the network server 100, to the transmitter/receiver 321 in the order in which the packets were stored.

The packet buffer 324 receives, via the transmitter/receiver 321, the packets transmitted from the network server 100 and stores the received packets. Then, the packet buffer 324 transfers the packets destined for the camera 30 or the monitor 40, to the transmitter/receiver 321 in the order in which the packets were stored. Also, when input with a packet containing information about the filtering conditions, the packet buffer 324 transfers the packet to the filter controller 325.

On receiving the packet containing information about the filtering conditions from the packet buffer 324, the filter controller 325 recognizes the filtering conditions and then sets the filtering conditions in the filtering condition table 326.

The filtering condition table 326 holds the set filtering conditions. For example, in the table may be set the filtering condition that only the packets destined for the network server 100 should be transferred.

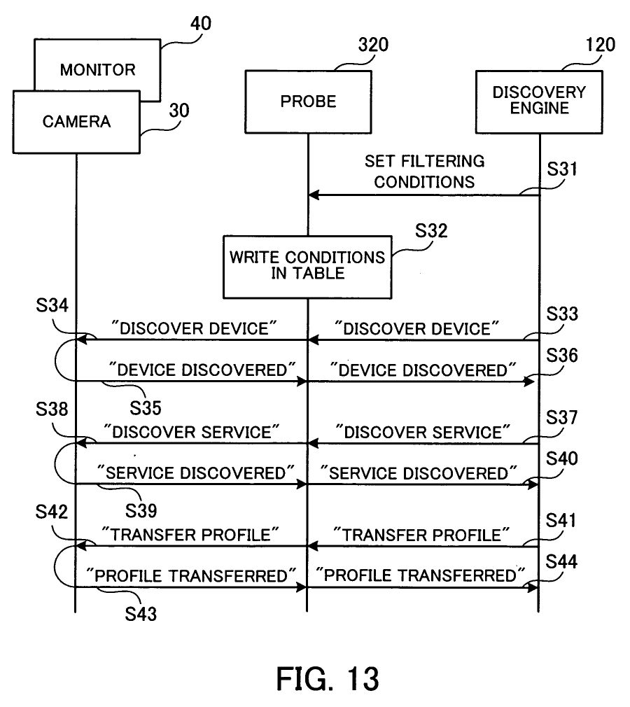

FIG. 13 is a sequence diagram illustrating the service profile collection process. In the following, the process shown in FIG. 13 will be explained in order of step number.

Step S31: The discovery engine 120 in the network server 100 transmits filtering conditions to the controller 300.

Step S32: The probe 320 in the controller 300 writes, in the filtering condition table 326, the filtering conditions transmitted from the network server 100. Specifically, the transmitter/receiver 321 receives the filtering conditions and stores same in the packet buffer 324. The filter controller 325 then acquires the filtering conditions from the packet buffer 324 and sets the contents of the filtering conditions in the filtering condition table 326.

Step S33: The discovery engine 120 of the network server 100 transmits a “DISCOVER DEVICE” instruction to the controller 300.

Step S34: The probe 320 in the controller 300 broadcasts the “DISCOVER DEVICE” instruction to the target LAN 22.

Step S35: On receiving the “DISCOVER DEVICE” instruction, each of the camera 30 and the monitor 40 returns, to the probe 320, a “DEVICE DISCOVERED” response indicating that it is a device operating on the target LAN 22.

Step S36: The probe 320 in the controller 300 forwards, to the network server 100, the “DEVICE DISCOVERED” responses transmitted from the camera 30 and the monitor 40. The “DEVICE DISCOVERED” responses are received by the discovery engine 120 of the network server 100.

Step S37: The discovery engine 120 in the network server 100 transmits, to the controller 300, “DISCOVER SERVICE” instructions specifying, as their destinations, the devices which have returned the “DEVICE DISCOVERED” response.

Step S38: The probe 320 in the controller 300 transfers the “DISCOVER SERVICE” instructions, received from the network server 100, to the camera 30 and the monitor 40, respectively.

Step S39: On receiving the “DISCOVER SERVICE” instruction, each of the camera 30 and the monitor 40 returns, to the probe 320, a “SERVICE DISCOVERED” response indicating that it can provide Task Computing service.

Step S40: The probe 320 in the controller 300 forwards, to the network server 100, the “SERVICE DISCOVERED” responses transmitted from the camera 30 and the monitor 40. The “SERVICE DISCOVERED” responses are received by the discovery engine 120 of the network server 100.

Step S41: The discovery engine 120 in the network server 100 transmits, to the controller 300, “TRANSFER PROFILE” instructions specifying, as their destinations, the devices which have returned the “SERVICE DISCOVERED” response.

Step S42: The probe 320 in the controller 300 transfers the “TRANSFER PROFILE” instructions, received from the network server 100, to the camera 30 and the monitor 40, respectively.

Step S43: On receiving the “TRANSFER PROFILE” instruction, each of the camera 30 and the monitor 40 returns its service profile to the probe 320.

Step S44: The probe 320 in the controller 300 forwards, to the network server 100, the service profiles transmitted from the camera 30 and the monitor 40. The service profiles are received by the discovery engine 120 of the network server 100.

Thus, the service controller 100a is provided in the network server 100, and it is therefore possible to determine based on the personal information of the user 50 etc. whether services can be provided or not. As a result, only the services which the user 50 is authorized to use can be extracted to be composed by the composition engine 130 so that the user may be notified of only those services available to him/her.

Also, the available services are rearranged in accordance with the personal information such as the user's likings and the history of the user's past selections, so that services which are very likely to be used by the user are displayed preferentially over others (at the top of the list). It is therefore possible to shorten the time necessary for the user to locate a target service from among the available services. Namely, the convenience of Task Computing can be enhanced.

Further, the backend server takes care of executing the service composition/control process based on the service profiles collected via the controller 300, and this makes it possible to lower the processor capacity required of the controller 300. As a result, controllers small in size as well as in power consumption can be fabricated.

Also, the service composition calculation is performed by the server, and this permits a significantly large storage capacity to be allocated to the information required for the calculation and also permits the other information saved on the server to be readily used in combination for the calculation.

The access permission list of devices installed in a corporation is held in a database and is looked up, thus making it possible to easily determine whether discovered devices can be used or not and to maintain the integrity of information.

### Second Embodiment

A second embodiment of the invention will be now described. In the second embodiment, the controller is provided with maximum functionality in respect of the process of discovering devices and services, thereby reducing the number of times the controller and the network server communicate with each other. Specifically, the probe exchanges simple messages with discovered devices and combines multiple service profiles into one. The probe then transmits a single piece of combined information to the network server. This serves to mitigate the load on the network server.

The second embodiment differs from the first embodiment in the function of exchanging messages between the discovery engine of the network server and the probe. In the following description, therefore, the elements other than the probe and the discovery engine will be referred to by the same reference numerals as those used in the first embodiment.

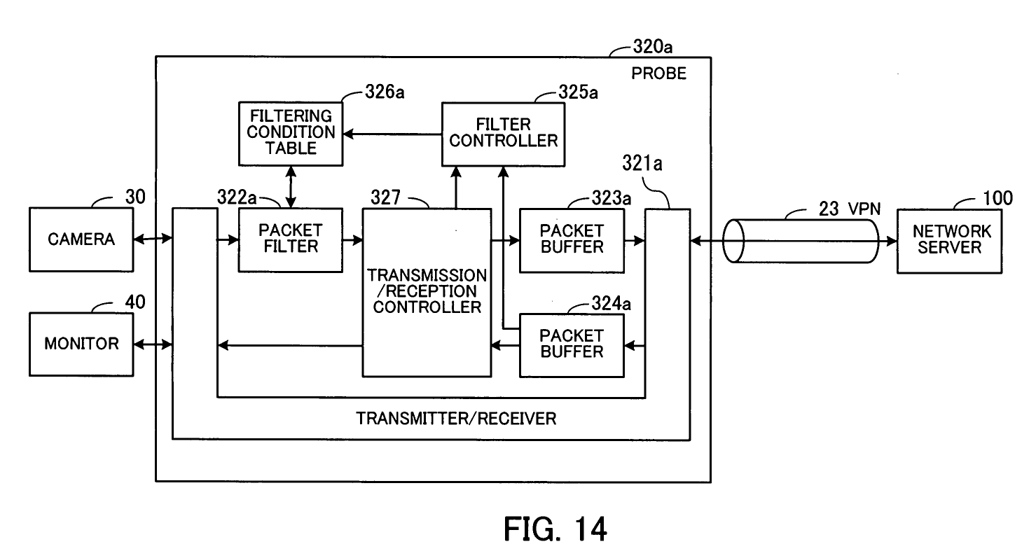

FIG. 14 illustrates the arrangement of the probe according to the second embodiment. The probe 320a comprises a transmitter/receiver 321a, a packet filter 322a, packet buffers 323a and 324a, a filter controller 325a, a filtering condition table 326a, and a transmission/reception controller (sequencer) 327. Thus, the second embodiment differs from the first embodiment in that the probe 320a additionally includes the transmission/reception controller 327.

The functions of the transmitter/receiver 321a, packet filter 322a, packet buffers 323a and 324a, filter controller 325a and filtering condition table 326a are basically identical with those of the transmitter/receiver 321, packet filter 322, packet buffers 323 and 324, filter controller 325 and filtering condition table 326 of the probe 320 (FIG. 12) of the first embodiment.

The transmission/reception controller 327 is located between the output of the packet buffer 324a and the transmitter/receiver 321a and at the same time between the output of the packet filter 322a and the packet buffer 323a. The transmission/reception controller 327 has the function of discovering devices connected to the target LAN 22 and collecting service profiles from the discovered devices.

A procedure for exchanging messages between the probe 320a configured as described above and the network server 100 will be now described. The example explained below is based on the assumption that the UPnP (Universal Plug and Play) protocol is used for the discovery of devices and the transfer of device profiles. UPnP is a technical specification so prescribed that personal computers, peripheral devices, electrical appliances, etc. at home may be interconnected by a network to allow the function of one device to be used by others.

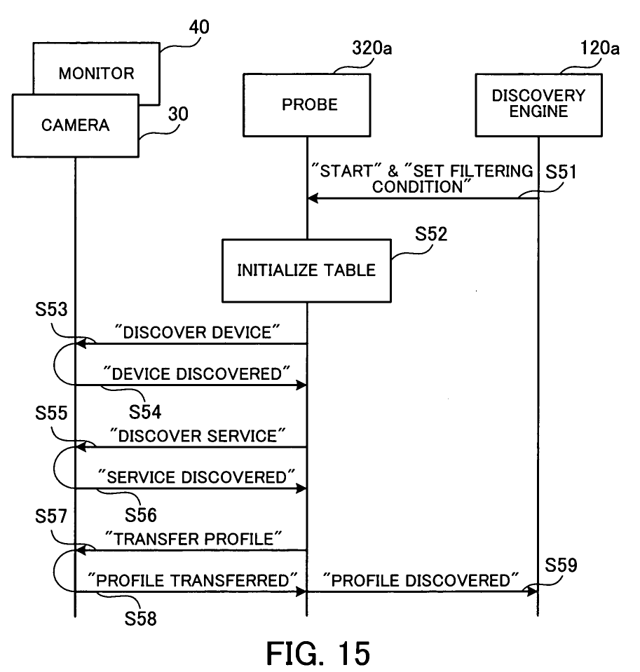

FIG. 15 is a sequence diagram illustrating a service profile collection process according to the second embodiment. In the following, the process shown in FIG. 15 will be explained in order of step number.

Step S51: The discovery engine 120a in the network server 100 transmits, to the controller 300, a “START” instruction to start the transmission/reception controller 327 as well as a “SET FILTERING CONDITION” instruction.

Step S52: The probe 320a in the controller 300 writes, in the filtering condition table 326a, the filtering conditions transmitted from the network server 100.

Step S53: The probe 320a in the controller 300 broadcasts a “DISCOVER DEVICE” instruction to the target LAN 22. Specifically, the transmission/reception controller 327, which has been started by the “START” instruction from the discovery engine 120a, transmits the “DISCOVER DEVICE” instruction.

Step S54: On receiving the “DISCOVER DEVICE” instruction, each of the camera 30 and the monitor 40 returns, to the probe 320a, a “DEVICE DISCOVERED” response indicating that it is a device operating on the target LAN 22.

Step S55: The probe 320a in the controller 300 transmits a “DISCOVER SERVICE” instruction to each of the camera 30 and the monitor 40. Specifically, the “DEVICE DISCOVERED” responses, transmitted in Step S54, are received by the transmission/reception controller 327, which then transmits “DISCOVER SERVICE” instructions whose destinations are the camera 30 and the monitor 40, respectively.

Step S56: On receiving the “DISCOVER SERVICE” instruction, each of the camera 30 and the monitor 40 returns, to the probe 320a, a “SERVICE DISCOVERED” response indicating that it can provide Task Computing service.

Step S57: The probe 320a in the controller 300 transmits a “TRANSFER PROFILE” instruction to each of the camera 30 and the monitor 40. Specifically, the “SERVICE DISCOVERED” responses, transmitted in Step S56, are received by the transmission/reception controller 327, which then transmits “TRANSFER PROFILE” instructions whose destinations are the camera 30 and the monitor 40, respectively.

Step S58: On receiving the “TRANSFER PROFILE” instruction, each of the camera 30 and the monitor 40 returns its service profile to the probe 320a.

Step S59: The probe 320a in the controller 300 forwards, to the network server 100, the service profiles transmitted from the camera 30 and the monitor 40. The service profiles are received by the discovery engine 120a of the network server 100.

In this manner, packets exchanged several times between the controller and the devices are not transmitted to the server and only the ultimately necessary device profiles can be transmitted to the server.

### Third Embodiment

A third embodiment of the invention will be now described. In the third embodiment, the user receives video content delivery service by means of Task Computing.

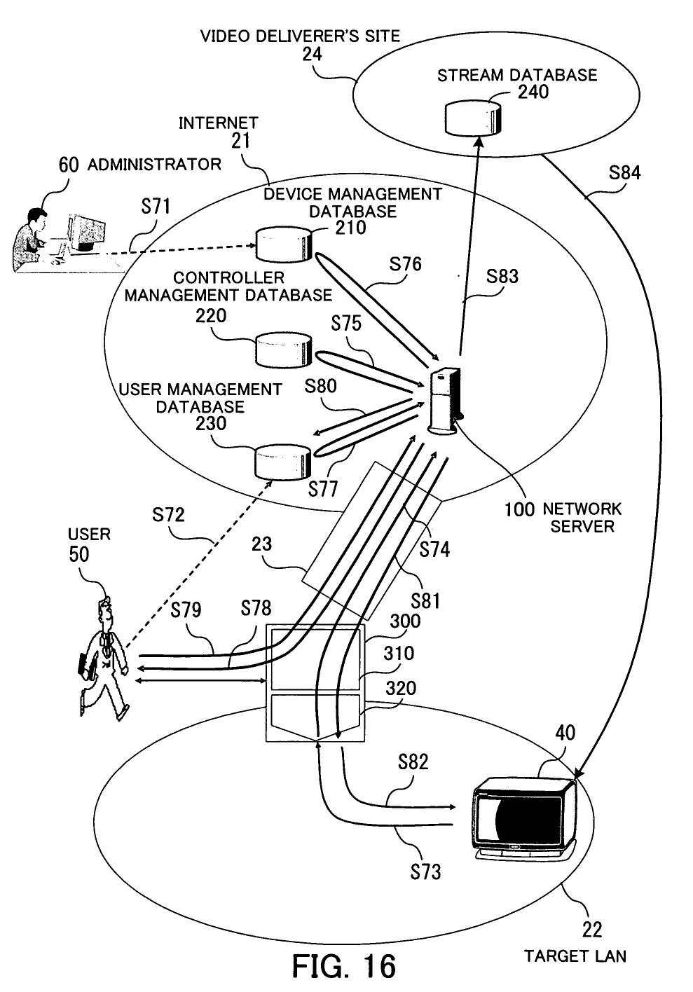

FIG. 16 shows an exemplary system configuration according to the third embodiment. The figure exemplifies service provision whereby the user 50 can have a video stream, which he/she is authorized to view, downloaded and displayed on the monitor 40 nearby.

The system configuration is basically identical with that of the first embodiment shown in FIG. 8 and differs therefrom in that a stream database 240 is installed at a video delivery corporation's site 24. It is assumed here that information about the stream data which the user 50 is authorized to view, among those delivered by the stream database 240, is registered in the user management database 230.

Also, the procedure for discovering and composing services is nearly identical with that explained above with reference to the first embodiment but differs therefrom in that a video stream of a format that the discovered monitor 40 can display, among those which the user is authorized to view, is selected in accordance with the information about the monitor 40. Namely, Steps S71 through S81 shown in FIG. 16 are identical in content with Steps S11, S12, and S15 to S23 shown in FIG. 8. In the following, therefore, no explanation will be made of the steps identical with those shown in FIG. 8 and only the differences will be explained.

On receiving a request for provision of stream data delivery service from the video delivery corporation's site 24, the network server 100 instructs the monitor 40 to receive and reproduce the stream data from the stream database 240 (Step S82). Further, the network server 100 transmits, to the stream database 240, a transmit instruction to transmit the specified stream data to the monitor 40 (Step S83), whereupon the stream data is transferred to the monitor 40 by pull operation of the monitor 40 or by push operation of the stream database 240 (Step S84). As a result, the stream data is reproduced by the monitor 40 and displayed on the screen thereof.

Other Exemplary Applications:

The systems of the foregoing embodiments can be used widely as device control schemes in a ubiquitous society where devices connected to networks exist everywhere. Specifically, a wireless LAN may be used as the target LAN 22 and also an intranet in a corporation may be used in place of the Internet 21.

In the above embodiments, databases are used to hold various kinds of information, but memory tables may simply be used instead.

In the first and second embodiments, control messages are transmitted to individual devices via the probe 320 of the controller 300 since the devices are not directly connected to the network server 100. In cases where the network server 100 and the individual devices (camera 30, monitor 40) can directly exchange data with each other, control message may be transmitted directly from the network server 100 to the individual devices. By relieving the controller of the process associated with the transmission of control messages, it is possible to lessen the load on the controller.

The processing function described above can be performed by a computer. In this case, a program is prepared in which is described the process for performing the function of the network server 100 or the controller 300. The program is executed by a computer, whereupon the aforementioned processing function is accomplished by the computer. The program describing the process may be recorded on computer-readable recording media. As such computer-readable recording media, magnetic recording devices, optical discs, magneto-optical recording media, semiconductor memories, etc. may be used. Magnetic recording devices include a hard disk drive (HDD), a flexible disk (FD), a magnetic tape, etc. Optical discs include a DVD (Digital Versatile Disc), a DVD-RAM (Random Access Memory), a CD-ROM (Compact Disc Read Only Memory), a CD-R (Recordable)/RW (ReWritable), etc. Magneto-optical recording media include an MO (Magneto-Optical disk) etc.

To market the program, portable recording media, such as DVDs and CD-ROMs, on which the program is recorded may be put on sale. Alternatively, the program may be stored in the storage device of a server computer and may be transferred from the server computer to other computers via a network.

A computer which is to execute the program stores in its storage device the program recorded on a portable recording medium or transferred from the server computer, for example. Then, the computer loads the program from its storage device and performs the process in accordance with the program. The computer may load the program directly from the portable recording medium to perform the process in accordance with the program. Also, as the program is transferred from the server computer, the computer may sequentially execute the process in accordance with the received program.

According to the present invention, services available to users are determined in accordance with the usage conditions stored in the management database, whereby advanced judgments as to the availability of services can be made based on detailed usage conditions. Consequently, high-grade service control such as service provision control matching the user's authority can be performed also in the Task Computing framework.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium recording a service control program for controlling services that can be provided through collaboration of devices on a network to which a controller is connected,
wherein the service control program causes a computer to function as:
device detector means for communicating with the controller to collect service profiles of nearby devices connected to a network in the vicinity of the controller;
usage condition acquisition means for looking up a management database in which usage conditions for using individual devices are registered beforehand, to acquire usage conditions of the nearby devices corresponding to the service profiles acquired by the device detector means;
available service decision means for determining, based on the service profiles acquired by the device detector means and the usage conditions acquired by the usage condition acquisition means, available services that can be provided by one or more devices including the nearby devices; and
device controller means for remotely controlling a device which is used for providing an available service among those determined by the available service decision means, to provide the available service.

2. The computer-readable recording medium according to claim 1, wherein the device detector means acquires identification information of a user using the controller when collecting the service profiles from the nearby devices,
wherein the usage conditions include information about services which the user is authorized to use, and
wherein the available service decision means determines, as the available services, services which can be provided by one or more devices including the nearby devices and which the user is authorized to use.

3. The computer-readable recording medium according to claim 1, wherein the available service decision means generates a service list listing one or more available services by name and transmits the generated service list to the controller, and
wherein, when a service provision request specifying an optional service in the service list is received from the controller, the device controller means remotely controls the device used for providing the service specified by the service provision request, to provide the service.

4. The computer-readable recording medium according to claim 3, wherein information about likings of a user is registered as user information, and
wherein the available service decision means rearranges the names of the available services in accordance with the user information.

5. The computer-readable recording medium according to claim 3, wherein information about a history of services used by a user is registered as user information, and
wherein the available service decision means rearranges the names of the available services in accordance with the user information.

6. The computer-readable recording medium according to claim 1, wherein the device detector means exchanges messages with the nearby devices via the controller, to acquire the service profiles of the nearby devices.

7. The computer-readable recording medium according to claim 1, wherein the device detector means requests the controller to collect service profiles and receives, from the controller, a combined set of the service profiles collected from the nearby devices by the controller.

8. The computer-readable recording medium according to claim 1, wherein the device controller means remotely controls, via the controller, the device used for providing the available service.

9. The computer-readable recording medium according to claim 1, wherein the device controller means directly accesses the device used for providing the available service, to remotely control the device.

10. The computer-readable recording medium according to claim 1, wherein the available service decision means includes, in the available services, services which are provided by devices on a network different from the network to which the nearby devices are connected.

11. A service control device for controlling services that can be provided through collaboration of devices on a network to which a controller is connected, comprising:
device detector means for communicating with the controller to collect service profiles of nearby devices connected to a network in the vicinity of the controller;
usage condition acquisition means for looking up a management database in which usage conditions for using individual devices are registered beforehand, to acquire usage conditions of the nearby devices corresponding to the service profiles acquired by the device detector means;
available service decision means for determining, based on the service profiles acquired by the device detector means and the usage conditions acquired by the usage condition acquisition means, available services that can be provided by one or more devices including the nearby devices; and
device controller means for remotely controlling a device which is used for providing an available service among those determined by the available service decision means, to provide the available service.

12. A service control method implemented by a computer to control services that can be provided through collaboration of devices on a network to which a controller is connected, comprising the steps of:
causing device detector means to communicate with the controller, to collect service profiles of nearby devices connected to a network in the vicinity of the controller;
causing usage condition acquisition means to look up a management database in which usage conditions for using individual devices are registered beforehand, to acquire usage conditions of the nearby devices corresponding to the service profiles acquired by the device detector means;
causing available service decision means to determine, based on the service profiles acquired by the device detector means and the usage conditions acquired by the usage condition acquisition means, available services that can be provided by one or more devices including the nearby devices; and
causing device controller means to remotely control a device which is used for providing an available service among those determined by the available service decision means, to provide the available service.
